(19) United States
(12) Patent Application Publication
(10) Pub. No.: US 2014/0165942 A1
(43) Pub. Date: Jun. 19, 2014

(54) ENGINE-LUBRICANT OCTANE BOOST TO QUIET SPORADIC PRE-IGNITION

(71) Applicant: FORD GLOBAL TECHNOLOGIES, LLC, Dearborn, MI (US)

(72) Inventors: David Karl Bidner, Livonia, MI (US); Mark Allen Dearth, Dearborn, MI (US)

(73) Assignee: FORD GLOBAL TECHNOLOGIES, LLC, Dearborn, MI (US)

(21) Appl. No.: 13/719,133

(22) Filed: Dec. 18, 2012

(51) Int. Cl. F02B 43/00

(52) U.S. Cl. CPC F02B 43/00
USPC 123/1 A

(57) ABSTRACT

One embodiment provides an engine lubricant having an engine oil and an additive dissolved in the engine oil in an amount effective to quiet pre-ignition or knock due to ingress of the lubricant into a combustion chamber of an engine. The additive has a saturated vapor pressure less than 300 Torr at 370 Kelvin, and yields only volatile combustion products. Another embodiment provides a method to quiet pre-ignition or knock due to ingress of engine lubricant into a combustion chamber of an engine, based on adding into the engine lubricant an aromatic, nitrogen-containing compound having a saturated vapor pressure less than 300 Torr at 370 Kelvin, and yielding only volatile combustion products.

### TECHNICAL FIELD

This application relates to the field of motor vehicle engineering, and more particularly, to quieting pre-ignition or knock due to ingress of engine lubricant into a combustion chamber of an engine.

### BACKGROUND AND SUMMARY

A gasoline engine may be susceptible to knock under various speed and load conditions. Knock is commonly encountered at relatively high-load conditions, and may limit the allowable operating load of a gasoline engine. In some cases, the allowable load may be extended through the use of variable ignition timing, variable valve timing, and/or exhaust-gas recirculation (EGR). However, sporadic pre-ignition may also occur at relatively low engine load and low engine speed. Sometimes referred to as ‘mega knock’, this form of pre-ignition may be inert to the approaches noted above. Left unaddressed, sporadic pre-ignition may cause objectionable engine noise, loss of power, and damage to the engine.

The inventor herein infers that sporadic pre-ignition in a gasoline engine may be due to the ingress of lubricant oil into the combustion chamber of the engine. Small droplets of lubricant oil may enter the combustion chamber via piston-ring breathing (i.e., reverse blow-by), or via the positive crankcase ventilation (PCV) system. Due to the low auto-ignition temperature of lubricant oil, droplets of the oil when mixed with the intake air charge may spontaneously ignite during the compression stroke, resulting in pre-ignition. In principle, sporadic pre-ignition caused by lubricant-oil ingress may be addressed by addition of an octane booster to the engine lubricant. Accordingly, U.S. Pat. No. 7,262,155 to Ryan et al. discloses that certain octane boosters may be added to the lubricant in a flame-propagation engine to quiet the issue. However, the particular octane boosters disclosed in the reference may be undesirable for use in a modern gasoline engine. Such agents include organometallic compounds, which have non-volatile (e.g., metal oxide) combustion products. By inference, combustion of any organometallic compound is likely to leave behind a permanent residue on the surfaces of the combustion chamber and of the exhaust-system components, such as the turbine. Metal-containing combustion products may also poison or occlude emissions-control catalysts in the exhaust system. Moreover, in modern, EGR-equipped engine systems, non-volatile combustion residue may be carried through to the intake system, causing further difficulties. Other octane boosters mentioned in the reference are undesirable because of their high volatility, which may result in excessive oil pressure and rapid loss of the agent through the PCV system.

The inventor herein has recognized the disadvantages of the prior approaches to quieting engine pre-ignition and has therefore proposed a totally different series of octane-boosted engine lubricants. One embodiment provides an engine lubricant having an engine oil and an additive dissolved in the engine oil in an amount effective to quiet pre-ignition or knock due to ingress of the lubricant into a combustion chamber of an engine. The additive has a saturated vapor pressure less than 300 Torr at 370 Kelvin, and yields only volatile combustion products. Another embodiment provides a method to quiet pre-ignition or knock due to ingress of engine lubricant into a combustion chamber of an engine. The method includes adding into the engine lubricant an aromatic, nitrogen-containing compound having a saturated vapor pressure less than 300 Torr at 370 Kelvin, and yielding only volatile combustion products. In examples disclosed herein, the saturated vapor pressure of the additive is similar to that of the base engine oil, and combustion of the additive yields only fully volatile products. Such products will not form a residue on engine-system components, nor degrade emissions-control catalysts.

The summary above is provided to introduce a selected part of this disclosure in simplified form, not to identify key or essential features. The claimed subject matter, defined by the claims, is limited neither to the content of this summary nor to implementations that address the problems or disadvantages noted herein.

### BRIEF DESCRIPTION OF THE DRAWINGS

FIG. 1 schematically shows aspects of an example engine system in accordance with an embodiment of this disclosure.

FIG. 2 illustrates an example method to quiet pre-ignition or knock due to ingress of engine lubricant into the combustion chamber of an engine, in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

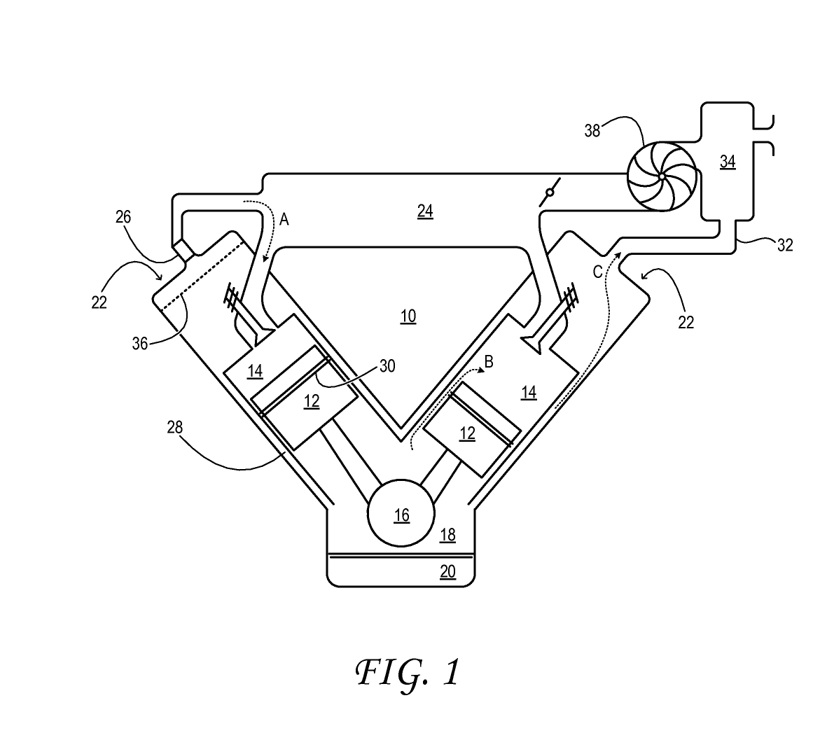

FIG. 1 schematically shows aspects of an example gasoline engine 10. The engine may include any number of pistons 12, which reciprocate within combustion chambers 14. The pistons are mechanically coupled to crankshaft 16, which rotates within crankcase 18. The crankcase contains a volume of engine lubricant 20, that circulates over and through the various moving parts of the engine. Such moving parts include cam-actuated linkages arranged beneath valve cover 22, in addition to the bearings and linkages of the crankshaft.

FIG. 1 shows aspects of a PCV system for reducing the accumulation of fuel, water, and other combustion products in the engine lubricant. In particular, intake manifold 24 is coupled through PCV valve 26 to the air space below valve cover 22. This air space communicates through engine jacket 28 to crankcase 18. Fuel vapor, water vapor, and other combustion products that may have entered the crankcase across piston rings 30 are suctioned out of the crankcase through the PCV valve, and into the intake manifold. The resulting vacuum within the crankcase is relieved through a ventilation line 32, which brings in fresh air from air cleaner 34.

The flow of air through crankcase 18 en route to intake manifold 24 may entrain aerosolized engine lubricant. Accordingly, an oil separator 36 may be arranged below valve cover 22 and configured to separate entrained oil droplets from the flowing air. However, the oil separator may still allow some oil droplets to be carried into the intake manifold, and then on to the combustion chamber. This route is labeled A in FIG. 1. Furthermore, oil droplets may enter the combustion chamber directly across piston rings 30, in a process known as ‘reverse blow-by’—i.e., the reverse of the blow-by process by which combustion products enter the crankcase. This route is labeled B in FIG. 1. Due to the low auto-ignition temperature of the lubricant oil of the engine lubricant, droplets of the lubricant, when mixed with the intake air charge, may spontaneously ignite during the compression stroke of pistons 12, resulting in increased pre-ignition, and/or increased knock.

In a downsized, gasoline turbocharged direct-injection (GTDI) engine, such as the one shown in FIG. 1, the rate of ingress of lubricant through the PCV system may be further increased due to the action of the piston cooling jets (PCJ, not shown in FIG. 1), which significantly increase the overall lubricant flow rate, resulting in a greater concentration of lubricant aerosol in the crankcase. In addition, a GTDI is typically operated under prolonged boost from compressor 38, when the PCV flow is not actively diluted with air, but rather flows ‘backwards’ into the clean-air inlet. This mode provides yet another route for lubricant oil ingress into the combustion chamber—the route labeled C in FIG. 1.

To address these issues while providing still other advantages, this disclosure describes various methods to quiet pre-ignition or knock due to ingress of engine lubricant into a combustion chamber of an engine. The methods are enabled by and described with continued reference to the above configurations. It will be understood, however, that the methods here described, and others fully within the scope of this disclosure, may be enabled by other configurations as well.

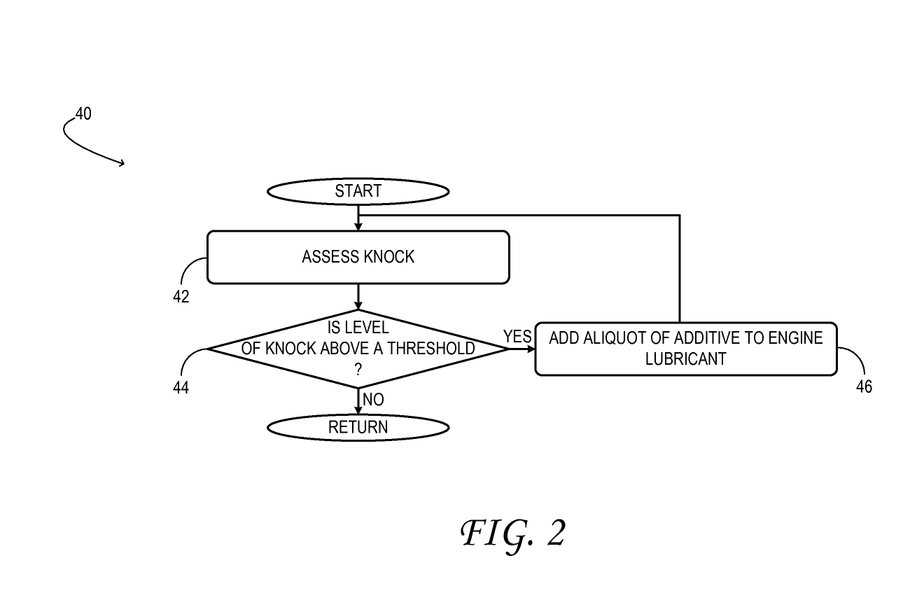

FIG. 2 illustrates an example method to quiet pre-ignition or knock due to ingress of engine lubricant into a combustion chamber of an engine. In this example, an octane-boosting additive is added to the lubricant 20 of a motor-vehicle engine. The additive may be added in an amount effective to quiet pre-ignition or knock due to ingress of the lubricant into a combustion chamber of the engine. In one embodiment, the amount effective may be determined empirically—e.g., by adding an aliquot of the additive to the engine lubricant and then operating the engine, with the lubricant, in a manner known to manifest sporadic pre-ignition in the absence of the additive. This is the general approach taken in method 40.

At 42 of method 40, the level of pre-ignition or knock exhibited by the engine is assessed under a standard set of conditions. Such conditions may include low engine speed and low engine load, where sporadic pre-ignition due to lubricant ingress is commonly observed. The assessment may be qualitative or quantitative. In one embodiment, pre-ignition or knock detection may be enacted in an on-board diagnostics system of the motor vehicle in which the engine is installed. In other embodiments, pre-ignition or knock may be detected via a piezoelectric element mechanically coupled to the engine block and electronically coupled to suitable filtering and amplification componentry, where the control system differentiates between pre-ignition and knock based on an intensity of vibration detection, a crank angle window of detection, or both. At 44 it is determined whether the assessed level of the pre-ignition or knock exceeds a predetermined threshold. If the level of the pre-ignition or knock exceeds the threshold, then an aliquot of the additive, at 46, is added to the engine lubricant. The aliquot may be added through the oil fill cap of the engine, for example. The method then returns to 42, where the level of pre-ignition or knock is again assessed.

This process may be repeated until sporadic pre-ignition is silenced, or is reduced to an acceptable level, or until a pre-determined maximum amount of the additive has been added to the lubricant. In one embodiment, the additive may be added directly to the crankcase 18 of the engine; the lubricant to which the additive is added may be a formulated engine lubricant already present in the crankcase of the engine.

In other embodiments, the additive may be combined with a formulated engine lubricant or with a base engine oil before the lubricant is introduced into the engine. Accordingly, another embodiment of this disclosure provides an engine lubricant per se. The engine lubricant includes an engine oil and an additive dissolved in the engine oil in an amount effective to quiet pre-ignition or knock due to ingress of the lubricant into a combustion chamber of an engine. In the embodiments contemplated herein, the engine oil may include a petroleum-based oil and/or a synthetic oil. In one embodiment, the amount effective to quiet the pre-ignition or knock may be an amount effective to reduce a level of pre-ignition or knock exhibited by the engine when the engine is lubricated by the engine oil without the additive. It may be determined based on the size, model, age, and/or service history of the engine. Naturally, the octane-boosting additive may be one of a plurality of additives dissolved in the engine oil; such additives may include one or more of a detergent and a viscosity modifier, for example.

In one embodiment, the additive may be added into the engine lubricant as a neat liquid. In other embodiments, the additive may be added as a solution in a formulated engine lubricant, in another lubricant additive, or in a base engine oil. In the embodiments contemplated herein, the additive may be a compound that increases an auto-ignition temperature of the lubricant—e.g., the so-called elevated-pressure auto-ignition temperature—relative to that of the base engine oil. Further, the additive may be a compound or mixture of compounds that has a saturated vapor pressure less than 300 Torr at 370 Kelvin and yields only volatile combustion products. In some embodiments, the saturated vapor pressure of the additive may be 100 Torr or less at 370 Kelvin. In still other embodiments, the saturated vapor pressure of the additive may be 50 Torr or less.

For convenience, the saturated vapor pressure p of a liquid can be estimated at a desired temperature T via the Antoine equation,

$$p = exp ( A - \frac{B}{C - T} ) ,$$

provided that the empirical constants A, B, and C are known or can be estimated. Alternatively, the saturated vapor pressure can be estimated via the Clausius-Clapeyron equation,

$$ln \frac{p}{{p}_{1}} = \frac{Δ H}{R} ( \frac{1}{{T}_{1}} - \frac{1}{T} ) ,$$

where ΔH is the enthalpy of vaporization of the liquid, R is the universal gas constant, and p₁ is a known saturated vapor pressure at a known temperature T₁—e.g., the boiling point of the liquid.

In some embodiments, the octane-boosting additive may include an aromatic, nitrogen-containing compound such as aniline (C₆H₅NH₂) or pyrrole (C₄H₄NH). Using the Antoine equation, the saturated vapor pressure of aniline at 370 Kelvin is about 40 Torr. Using the Clausius-Clapeyron equation, the saturated vapor pressure of pyrrole is about 280 Torr. In these and other embodiments, the additive may include an N-arylated aniline—e.g., diphenylamine, triphenylamine, or a substituted di- or triphenylamine. In these and other embodiments, the additive may include an alkylated pyrrole, such as 2-methylpyrrole, 2,5-dimethylpyrrole, or 2-ethyl-5-methylpyrrole, as examples. Other suitable aromatic, nitrogen-containing additives are as listed in U.S. Pat. No. 2,844,520 to Vilaud, in the context of improving the anti-auto-ignition properties of gasoline. This reference is hereby incorporated by reference herein, for all purposes.

In some embodiments, the basicity of the additive may be low, such that it does not promote corrosion of engine and exhaust system components, such as metal surfaces and seals. Accordingly, the once protonated form of the additive may have a pKₐ of 5 or lower in aqueous solution, or 3 or lower in some examples. The pKₐ of anilinium (C₆H₅NH₃⁺) is 4.6, for comparison, and the pKₐ of pyrrolium is −3.8. Further, the additive may be chosen such that its volatile combustion products will degrade no emissions-control catalyst in the exhaust system coupled to the engine. In other words, the combustion products will neither deactivate nor occlude the catalysts. In one embodiment, the combustion products may be limited to water vapor, carbon dioxide, carbon monoxide, and dinitrogen. In these and other embodiments, the volatile combustion products derived from combustion of the additive may be gasses at 760 Torr and 500 Kelvin, which are conditions typically found in the exhaust system of a gasoline engine.

Some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used. It will be understood that the articles, systems, and methods described hereinabove are embodiments of this disclosure—non-limiting examples for which numerous variations and extensions are contemplated as well. This disclosure also includes all novel and non-obvious combinations and sub-combinations of the above articles, systems, and methods, and any and all equivalents thereof.

1. An engine lubricant comprising:
an engine oil; and
an additive dissolved in the engine oil in an amount effective to quiet knock or preignition due to ingress of the lubricant into a combustion chamber of an engine, the additive having a saturated vapor pressure less than 300 Torr at 370 Kelvin and yielding only volatile combustion products.

2. The lubricant of claim 1 wherein the amount effective to quiet the pre-ignition or knock is an amount effective to reduce a level of pre-ignition or knock exhibited by the engine when the engine is lubricated by the engine oil without the additive.

3. The lubricant of claim 1 wherein the additive increases an auto-ignition temperature of the lubricant relative to the auto-ignition temperature of the engine oil.

4. The lubricant of claim 1 wherein the additive includes aniline.

5. The lubricant of claim 1 wherein the additive includes an N-arylated aniline.

6. The lubricant of claim 1 wherein the additive includes pyrrole.

7. The lubricant of claim 1 wherein the additive includes an alkylated pyrrole.

8. The lubricant of claim 1 wherein a once-protonated form of the additive has a pKₐ of 5 or less.

9. The lubricant of claim 1 wherein the volatile combustion products degrade no catalyst of an exhaust system coupled to the engine.

10. The lubricant of claim 1 wherein the volatile combustion products are gasses at 760 Torr and 500 Kelvin.

11. The lubricant of claim 1 wherein the engine oil is a petroleum-based oil.

12. The lubricant of claim 1 wherein the engine oil is a synthetic oil.

13. The lubricant of claim 1 wherein the additive is one of a plurality of additives dissolved in the engine oil, and wherein the plurality of additives includes one or more of a detergent and a viscosity modifier.

14. An engine lubricant comprising:
an engine oil; and
an aromatic, nitrogen-containing compound dissolved in the engine oil in an amount effective to quiet pre-ignition due to ingress of the lubricant into a combustion chamber of an engine, the compound having a saturated vapor pressure less than 300 Torr at 370 Kelvin and yielding only volatile combustion products.

15. The lubricant of claim 1 wherein the additive includes aniline.

16. The lubricant of claim 1 wherein the additive includes an N-arylated aniline.

17. The lubricant of claim 1 wherein the additive includes pyrrole.

18. The lubricant of claim 1 wherein the additive includes an alkylated pyrrole.

19. A method to quiet pre-ignition due to ingress of engine lubricant into a combustion chamber of an engine, the method comprising:
adding into the engine lubricant an aromatic, nitrogen-containing compound having a saturated vapor pressure less than 300 Torr at 370 Kelvin and yielding only volatile combustion products.

20. The method of claim 19 wherein adding the compound into the engine lubricant includes adding one or more of aniline, an N-arylated aniline, pyrrole, and an alkylated pyrrole.
